(19) United States
(12) Patent Application Publication
(10) Pub. No.: US 2006/0004718 A1
(43) Pub. Date: Jan. 5, 2006

(54) Report layout model and method

(76) Inventors: Eric McCully, Gloucester (CA); Kevin Ferguson, Manotick (CA)

Correspondence Address: PEARNE & GORDON LLP, 1801 EAST 9TH STREET, SUITE 1200, CLEVELAND, OH, 44114-3108, US

(21) Appl. No.: 10/883,862

(22) Filed: Jul. 2, 2004

(51) Int. Cl. G06F 17/30

(52) U.S. Cl. 707/3

(57) ABSTRACT

A report layout model and method that provide layout content elements for structuring data from a query, and that further include layout rendering elements for rendering that query data. In an embodiment of the present invention, style elements are further provided in accordance with the Cascading Style Sheets (CSS) specification to improve rendering control.

### FIELD OF THE INVENTION

The present invention relates generally to electronic data modeling techniques, and more particularly to data modelling the layout of a report.

### BACKGROUND OF THE INVENTION

Business intelligence (BI) systems are gaining wide acceptance as a way of displaying business information from gathered sets of data stored in databases like a data warehouse. In a BI system, end users typically receive information from the system laid out in the form of reports. Solutions for laying out information in modern reporting systems generally fall into one of two categories, the first being a banded layout model, and the second being a paint layout model.

In the banded layout model, a report is broken into bands with each band representing a group header/footer or detail area. The banded layout model is generally used to do “list-style” reporting where information is displayed in bands repeating down a page. The problem with the banded layout model is that it is highly restrictive in the types of layouts one can build with it.

In the paint layout model by contrast, the layout of a report is seen as being “drawn onto a canvas”, as one would do if one were using a drawing application. This allows the author of a report to place objects in a fairly precise manner. The problem with the paint layout model is that since layout elements are independently placed on a “canvas”, they handle changes or conflicts with other elements poorly. For instance, when rendering a report on a different page size from the choice in the original paint layout model adjacent elements such as a table and a line of text can overlap one another.

It is therefore desirable to enable the creator of a report to control not only how the report will look, but also how the underlying elements of the report will behave in the dynamic environs of a modern reporting system.

For the foregoing reasons, there is a need for an improved report layout model.

### SUMMARY OF THE INVENTION

The present invention is directed to a report layout model and method. The model includes at least one report layout content element for providing structure to data generated from a query, and at least one report layout rendering element for rendering the generated query data in a report.

In an aspect of the present invention, the model further includes at least one report layout element contained within another report layout element.

In an aspect of the present invention, the model further includes at least one style element to improve control over rendering the content elements and the rendering elements within a report.

In an aspect of the present invention, the style element is provided in accordance with the Cascading Style Sheets (CSS) specification.

The method includes the steps of providing structure to data generated from a query using one or more than one report layout content element, and rendering the generated query data in a report using one or more than one report layout rendering element.

In an aspect of the present invention, the method further includes the step of containing at least one report layout element within another report layout element.

In an aspect of the present invention, the method further includes the step of providing one or more than one style element to improve control over rendering the content elements and the rendering elements within a report.

In an aspect of the present invention, the style element is provided in accordance with the Cascading Style Sheets (CSS) specification.

In contrast to the banded model, the report layout model allows an author the flexibility to layout the report as they desire, and in contrast to the paint model, the maintainability of the report is much higher. Changes to an element in the layout model will have a controlled effect on the other elements in that layout model. Unintentional overlapping of elements is thus minimized in the layout model.

The report layout model allows a report author to layout a report in a manner that is both flexible and easy to maintain. The layout model allows an author to define how the layout of a report will behave as much as it allows him to define how it looks.

The report layout model 10 provides the best of both worlds, since it provides the stability admired in the banded layout model as well as the flexibility evidenced by the paint layout model.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

These and other features, aspects, and advantages of the present invention will become better understood with regard to the following description, appended claims, and accompanying drawings where:

FIG. 1 is an overview of a report layout model in accordance with an embodiment of the present invention;

FIG. 2 is an overview of a report layout method in accordance with an embodiment of the present invention;

FIG. 3 shows the model with a layout element contained within another layout element;

FIG. 4 shows the method further including the step of containing a layout element within another layout element;

FIG. 5 illustrates an exemplary example of a crosstab report as rendered from the report layout model;

FIG. 6 illustrates an exemplary example of a chart report as rendered from the report layout model;

FIG. 7 illustrates an exemplary example of a repeater report as rendered from the report layout model;

FIG. 8a through 8e illustrate an exemplary example of a page set report as rendered from the report layout model;

FIG. 9 illustrates a report layout XML schema tree in accordance with the report layout model;

FIG. 10 illustrates an exemplary example of a list report as rendered from the report layout model;

FIG. 11 shows the model with a style element included; and

FIG. 12 shows the method further including the step of providing a style element to improve rendering control.

### DETAILED DESCRIPTION OF THE PRESENTLY PREFERRED EMBODIMENT

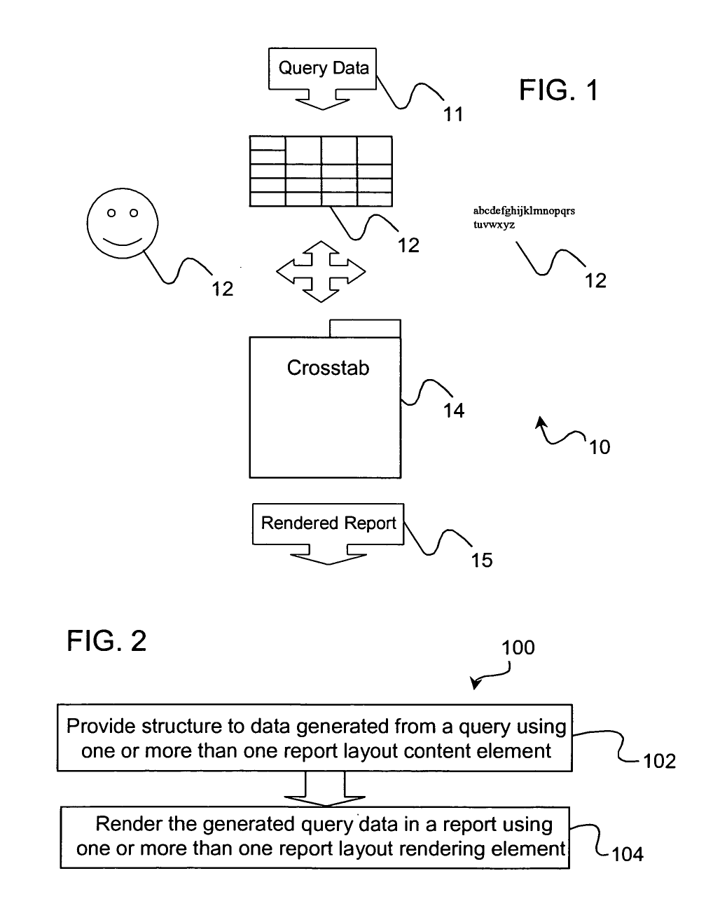

An embodiment of the present invention is directed to a report layout model 10 and method 100. As illustrated in FIG. 1, the model 10 includes at least one report layout content element 12 for providing structure to data 11 generated from a query, and at least one report layout rendering element 14 for rendering the generated query data in a report 15.

As illustrated in FIG. 2, the method 100 includes the steps of providing structure to data generated from a query using one or more than one report layout content element 102, and rendering the generated query data in a report using one or more than one report layout rendering element 104.

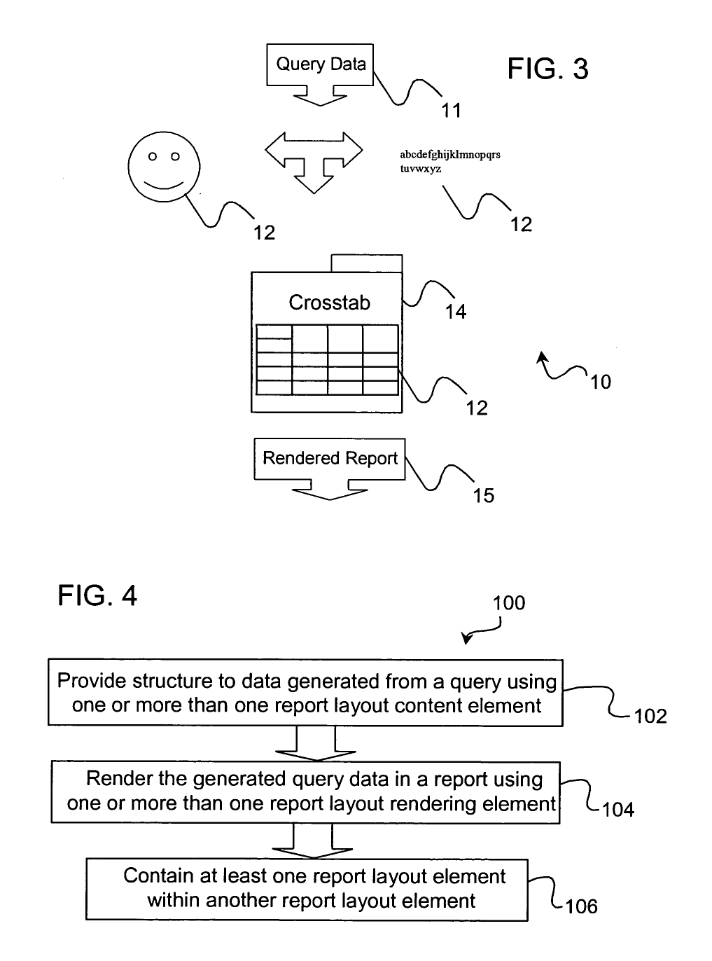

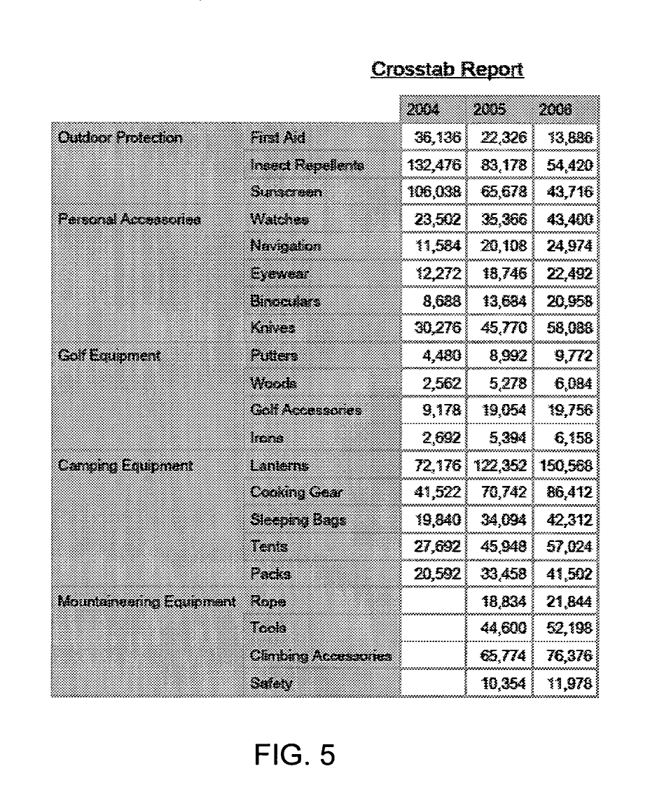

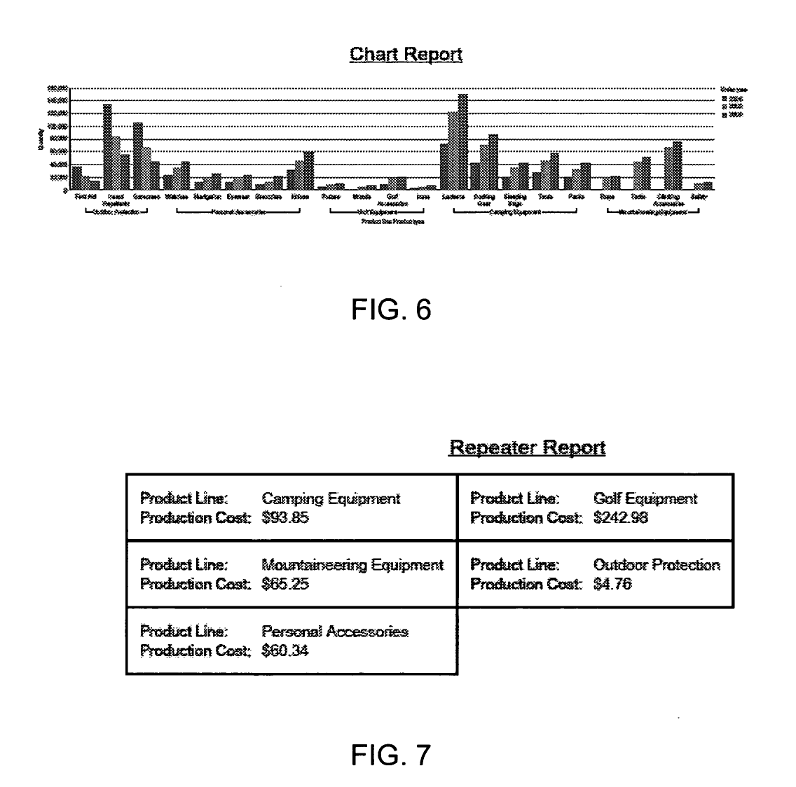

As illustrated in FIG. 3, in an embodiment of the present invention, the model 10 further includes at least one report layout element 12/14 contained within another report layout element 12/14.

As illustrated in FIG. 4, in an embodiment of the present invention, the method 100 further includes the step of containing at least one report layout element within another report layout element 106.

TABLE 1 lists examples of a report layout content element 12 in accordance with an embodiment of the report layout model 10 and method 100 that have rough equivalents in Hypertext Markup Language (HTML).

TABLE 1
Report Layout Content Elements

| Report Layout Content | Equivalent HTML Element |
|---|---|
| Element | (Prior Art) |
| Table (20) | TABLE |
| Block (22) | DIV |
| Text (24) | SPAN |
| Image (26) | IMG |
| Hyperlink (28) | A (with HREF attribute) |
| Button (30) | BUTTON |
| Bookmark (32) | A (with NAME attribute) |

A “table” report layout content element 20 is roughly equivalent to an HTML table.

A “block” report layout content element 22 represents a set of elements in a layout. It behaves similarly to a DIV (DIVISION) element or paragraph in HTML, and follows the HTML definition of a DIV element.

A “text” report layout content element 24 is used in the layout model 10 to render text. The data source of the text element 24 determines what text to render in a report.

An “image” report layout content element 26 is used in the layout model 10 to render an image in a report. The Universal Resource Locator (URL) for that image is determined by the data source of the image element 26.

A hyperlink” report layout content element 28 represents an HTML style anchor, with the hyperlink data source defining the URL to be used for that hyperlink element 28. A hyperlink element 28 can further perform the roll of a layout container and can therefore have other layout elements 12/14 contained within it.

A “button” report layout content element 30 is roughly equivalent to an HTML-style button hyperlink. The button hyperlink datasource defines the URL to be used for the button element 30. The button element 30 can also perform the roll of a layout container, and can therefore also have other layout elements 12/14 contained within it.

A “bookmark” report layout content element 32 allows for linking to a location in a rendered layout. The name of the bookmark element 32 is determined by its datasource, and is the rough equivalent of a named anchor in HTML, such as “<A NAME=“MyBookmark” ” for example.

Examples of a report layout rendering element 14 used to render data in various HTML forms are listed in TABLE 2.

TABLE 2
Report Layout Rendering Elements

| Report Layout | | |
|---|---|---|
| Element | Description | Sample Output |
| List (40) | Renders the data from a | |
| | query in a list style format | |
| Crosstab (42) | Renders the data from a | |
| | query in a crosstab style | |
| | format | |
| Chart (44) | Renders the data from a | |
| | query in a chart | |
| Repeater (46) | Renders the data from a | |
| | query in a table style | |
| | format | |
| Page Set (48) | Renders the data from a | FIG. 7 a-e |
| | query in multiple pages | |

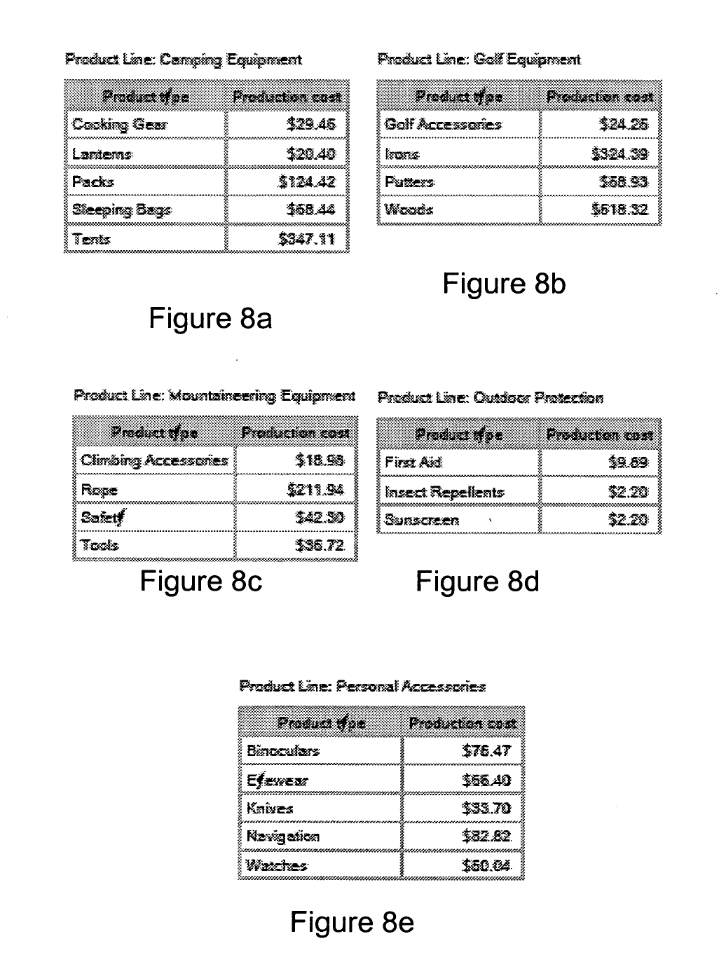

Since the “list” 40, “crosstab” 42, “repeater” 46 and “page set” 48 report layout rendering elements 14 can all further perform the roll of containers, their contents can be that of other report layout elements 12/14. For example, the repeater report illustrated in FIG. 7 contains a table element 20, and the page set report illustrated in FIGS. 8a through 8e contain a list element 40.

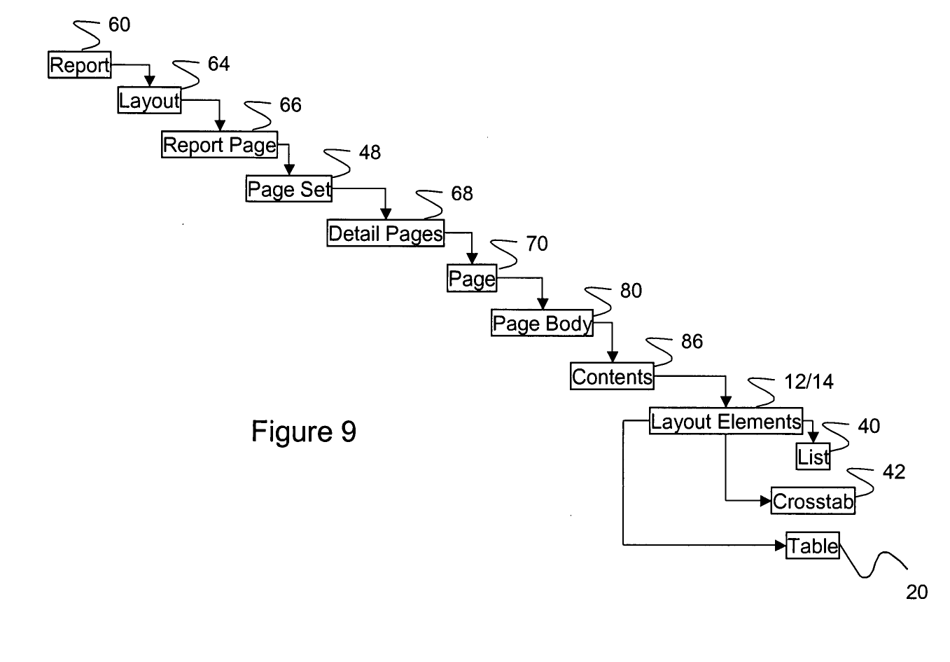

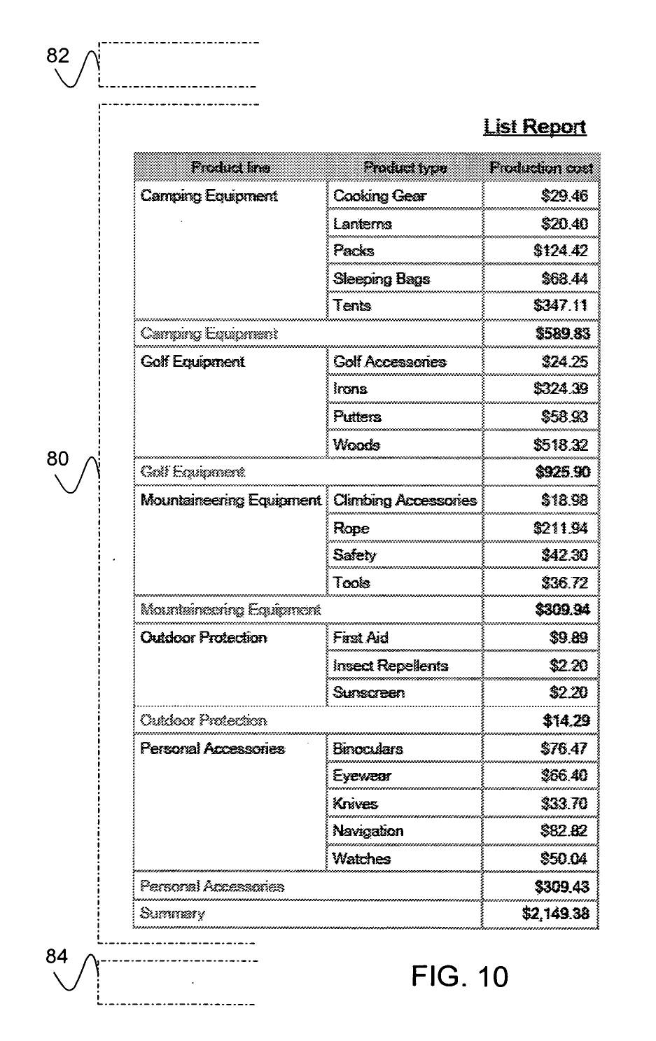

The report schema tree of an XML embodiment of the report layout model 10 is illustrated in FIG. 9 that includes a report component 60 containing an entire report specification 62. The report specification 62 includes a layout 64 comprised of report pages 66 organized into page sets 48 that are rendered in the order they occur. A page set 48 defines the controls for rendering the pages that that page set 48 contains. If the page set 48 references a query, then the pages or child page sets can be rendered according to a grouping structure defined for the entire page set 48.

Detail pages 68 are then rendered within the lowest level grouping of a page set. All detail rows from the page set query within the lowest level grouping are available for rendering. A detail page 68 can contain layout elements 12/14 that use the same query as the page set element 48. Included in the detail pages 68 is a page element 70 having a page body 80, and optionally a page header component 82 and/or a page footer component 84.

As illustrated in FIG. 10, regardless of the dimensions of the page, the page header 82 will always appear at the top and the page footer 84 will always appear at the bottom of the page. The page body component 80 will then take up the space that is remaining between the page header component 82 and the page footer component 84. The page body component 80 provides a container that can further include elements that define the contents 86 of that container, such as the layout elements 12/14 described in TABLES 1 and 2. Layout elements 12/14 are located from the contents element 12 and provide a choice of layout elements 12/14 from which to choose.

The report layout model and method allow an author to define how the layout of a report will behave as much as it allows him to define how it looks.

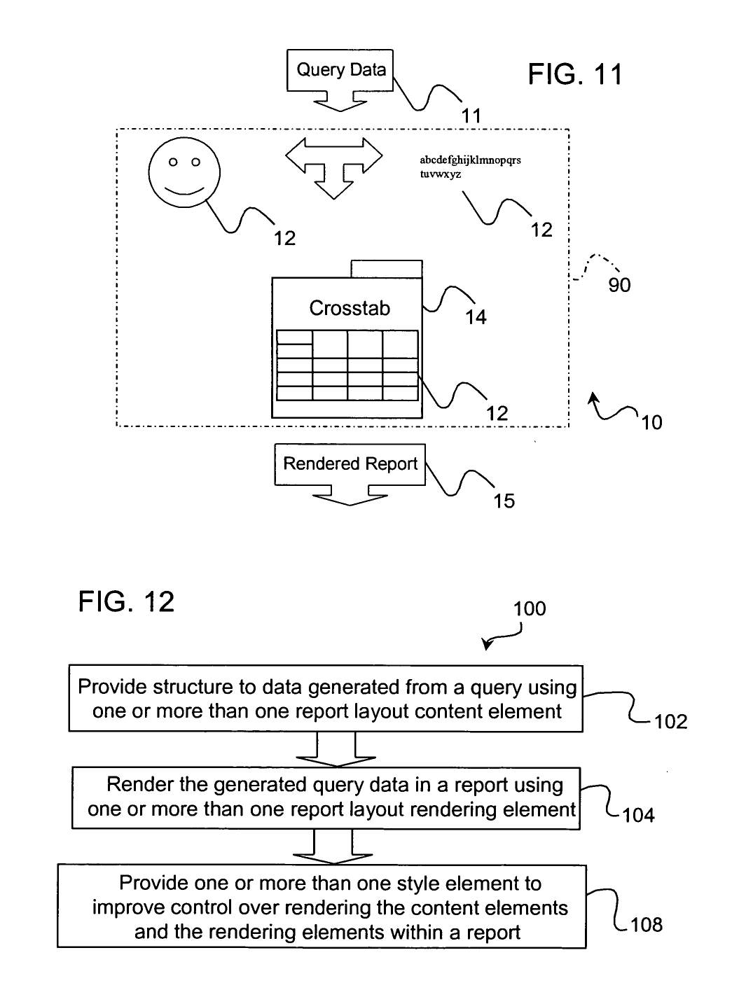

As illustrated in FIG. 11, in an embodiment of the present invention, the model 10 further includes at least one style element 90 to improve control over rendering the content elements and the rendering elements within a report.

As illustrated in FIG. 12, in an embodiment of the present invention, the style element 90 is provided in accordance with the Cascading Style Sheets (CSS) specification.

In an embodiment of the present invention, the method 100 further includes the step of providing one or more than one style element to improve control over rendering the content elements and the rendering elements within a report 108.

In an embodiment of the present invention, the style element is provided in accordance with the Cascading Style Sheets (CSS) specification.

With these report layout elements 12/14 that allow for the improved layout of data, the report layout model 10 and method 100 extend the HTML/CSS layout model.

The report layout model 10 and method 100 therefore provide a solution to the behavior of elements in a report model as much as how those elements will appear upon rendering.

In contrast to the banded model, the report layout model 10 and method 100 provide an author with the flexibility to layout a report as they so choose, and in contrast to the paint model, the maintainability of that report is much higher. The report layout model 10 and method 100 enable a report author to layout a report in a manner that is both flexible and easy to maintain, and where changes to an element in the layout will have a controlled effect on other elements in the layout. The unintentional overlapping of elements is therefore minimized.

Any hardware, software or a combination of hardware and software having the above-described functions may implement the report layout model 10 and method 100 according to the present invention, and methods described above. The software code, either in its entirety or a part thereof, may be in the form of a computer program product such as a computer-readable memory having the model and/or method stored therein.

Furthermore, a computer data signal representation of that software code may be embedded in a carrier wave for transmission via communications network infrastructure. Such a computer program product and a computer data signal are also within the scope of the present invention, as well as the hardware, software and combination thereof.

Therefore, although the present invention has been described in considerable detail with reference to certain preferred embodiments thereof, other versions are possible. Therefore, the spirit and scope of the appended claims should not be limited to the description of the preferred embodiments contained herein.

What is claimed is:

1. A report layout model comprising:
one or more than one report layout content element for providing structure to data generated from a query; and
one or more than one report layout rendering element for rendering said generated query data in a report.

2. The model according to claim 1, wherein one or more than one report layout element is contained within another report layout element.

3. The model according to claim 1, further including one or more than one style element to improve control over rendering said content elements and said rendering elements within a report.

4. The model according to claim 2, wherein said style element is provided in accordance with Cascading Style Sheets (CSS) specification.

5. The model according to claim 1, wherein said report layout content elements are selected from the list of elements consisting of table, block, text item, image, hyperlink button and bookmark report layout content elements.

6. The model according to claim 1, wherein said report layout rendering element is selected from the list of elements consisting of list, crosstab, chart, repeater and page set report layout rendering elements.

7. A report layout method comprising the steps of:
(i) providing structure to data generated from a query using one or more than one report layout content element; and
(ii) rendering said generated query data in a report using one or more than one report layout rendering element.

8. The method according to claim 7, further including the step of containing one or more than one report layout element within another report layout element.

9. The method according to claim 7, further including the step of providing one or more than one style element to improve control over rendering said content elements and said rendering elements within a report.

10. The method according to claim 9, wherein said step of providing one or more than one style element is performed in accordance with Cascading Style Sheets (CSS) specification.

11. A computer program product for a report layout method, the computer program product comprising:
a computer readable medium for storing machine-executable instructions for use in the execution in a computer of the report layout method, the method including the steps of:
providing structure to data generated from a query using one or more than one report layout content element; and
rendering said generated query data in a report using one or more than one report layout rendering element.
